(19) United States
(12) Patent Application Publication
(10) Pub. No.: US 2016/0286990 A1
(43) Pub. Date: Oct. 6, 2016

(54) CONTAINER FOR HOLDING AND PRESENTING A FOOD PRODUCT

(71) Applicant: JEAN-PHILIPPE MAURY, Rancho Santa Fe, CA (US)

(72) Inventor: JEAN-PHILIPPE MAURY, Rancho Santa Fe, CA (US)

(21) Appl. No.: 14/921,101

(22) Filed: Oct. 23, 2015

Related U.S. Application Data
(60) Provisional application No. 62/141,599, filed on Apr. 1, 2015.

(51) Int. Cl. A47G 19/02; A23G 3/56; B65D 51/24; B65D 85/78; B65D 25/04; B65D 43/02

(52) U.S. Cl. CPC A47G 19/025; B65D 25/04; B65D 43/0202; B65D 51/246; B65D 85/78; A23G 3/563

(57) ABSTRACT

A container having a primary bowl, a shallow bowl configured to removably attach to the primary bowl near a top of the primary bowl such that a top surface of the shallow bowl creates a support for a food product, the shallow bowl configured to cover a majority of a top opening of the primary bowl while creating one or more passageways from within the primary bowl to an area external to the primary bowl, the one or more passageways for allowing water fog from a mixture of dry ice and water placed in the primary bowl to escape creating a visual effect proximate the food product.

### CROSS-REFERENCE

This application claims priority to U.S. Patent Application No. 62/141,599 filed Apr. 1, 2015 and which is incorporated herein for any and all purposes.

### FIELD OF THE INVENTION

The embodiments of the present invention relate to a container for holding and presenting a dessert.

### BACKGROUND

Food is as much about presentation as it is taste. The presentation of desserts is especially important. Such presentation can persuade consumers to purchase a dessert.

It would be advantageous to develop a container for holding and presenting a dessert. Such container should create a dramatic presentation and encourage the purchase thereof.

### SUMMARY

Accordingly, one embodiment of the present invention is a container comprising: a primary bowl; a shallow bowl configured to removably attach to said primary bowl near a top of said primary bowl such that an upper surface of said shallow bowl creates a support for a food product, said shallow bowl configured to cover a majority of a top opening of said primary bowl while creating one or more passageways from within said primary bowl to an area external to said primary bowl, said one or more passageways for allowing water fog from a mixture of dry ice and water placed in said primary bowl to escape creating a visual effect proximate said food product.

In another embodiment, a semi-spherical lid fits onto said shallow bowl to protect said food product. An opening in a top of said lid accommodates a dropper for inserting a liquid flavoring into said food product contained beneath said lid and on said shallow bowl.

While any food product may be held and presented using the container described herein, desserts are ideal.

Other variations, embodiments and features of the present invention will become evident from the following detailed description, drawings and claims.

### BRIEF DESCRIPTION OF THE DRAWINGS

FIG. 1 illustrates a perspective upper view of a container without a food product according to the embodiments of the present invention;

FIG. 2 illustrates a perspective upper view of a container with a food product according to the embodiments of the present invention;

FIG. 3 illustrates a perspective upper view of a container with a food product as well as dry ice and water for creating a visual effect proximate said food product according to the embodiments of the present invention;

FIG. 4 illustrates a top view of a bowl of the container according to the embodiments of the present invention;

FIG. 5A illustrates a side view of the bowl of the container according to the embodiments of the present invention;

FIG. 5B illustrates an inside view of a top edge of the bowl of the container according to the embodiments of the present invention;

FIG. 6 illustrates a top view of a shallow bowl of said container according to the embodiments of the present invention;

FIG. 7A illustrates a side view of said shallow bowl of said container according to the embodiments of the present invention;

FIG. 7B illustrates a perspective top view of said shallow bowl of the container according to the embodiments of the present invention;

FIG. 8 illustrates a top view of a lid of said container according to the embodiments of the present invention;

FIG. 9 illustrates a side view of the lid of said container according to the embodiments of the present invention;

FIG. 10 illustrates a dropper according to the embodiments of the present invention;

FIG. 11 illustrates a meringue dessert of the type suitable for use with the container according to the embodiments of the present invention; and

FIG. 12 illustrates a spoon of the type suitable for eating a dessert of the type servable in the container according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

The components of the embodiments of the present invention may be fabricated of any suitable materials, including, but not limited to plastics, polymers, resins, composites and alloys. The components may be made using any suitable technique, including, but not limited to molding, machining and 3D printing.

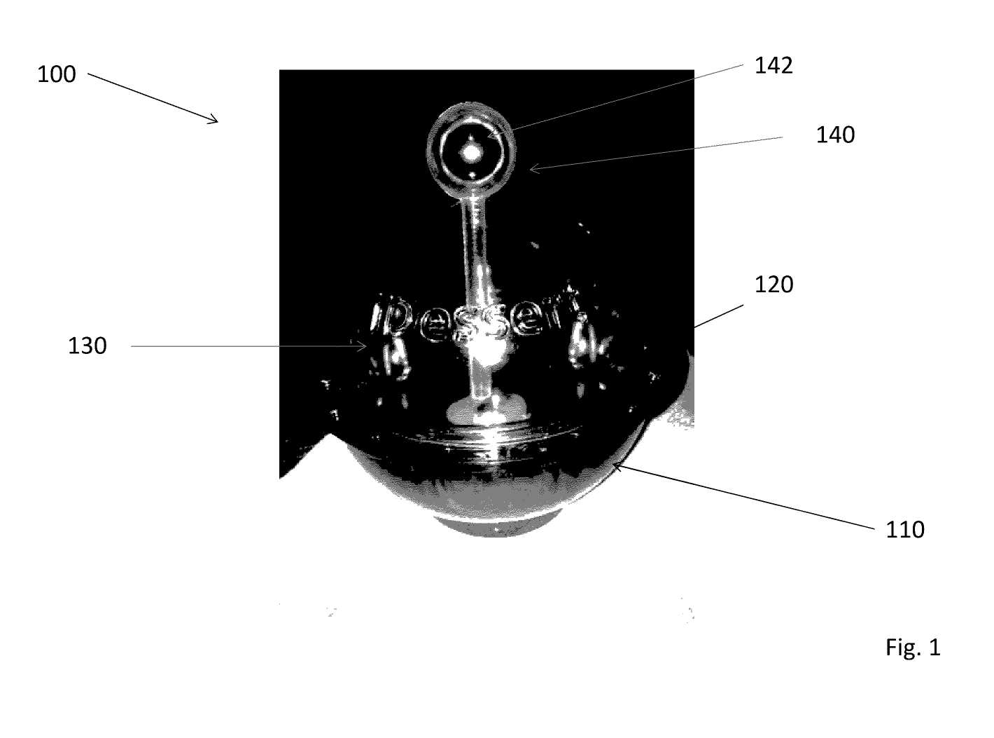

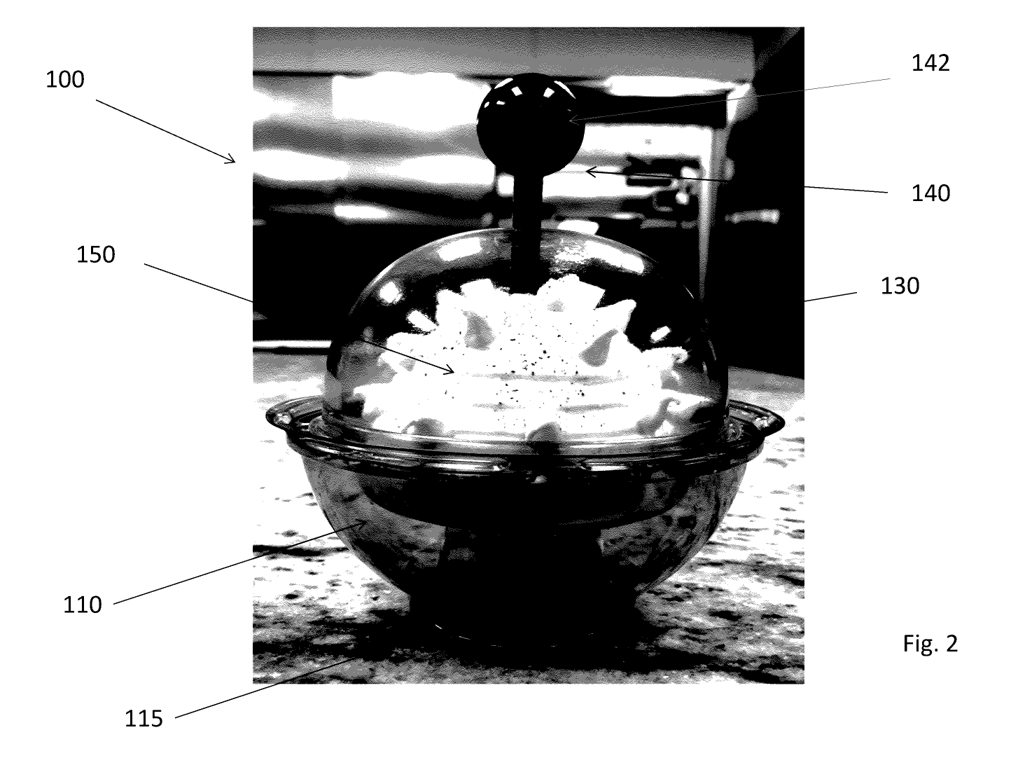

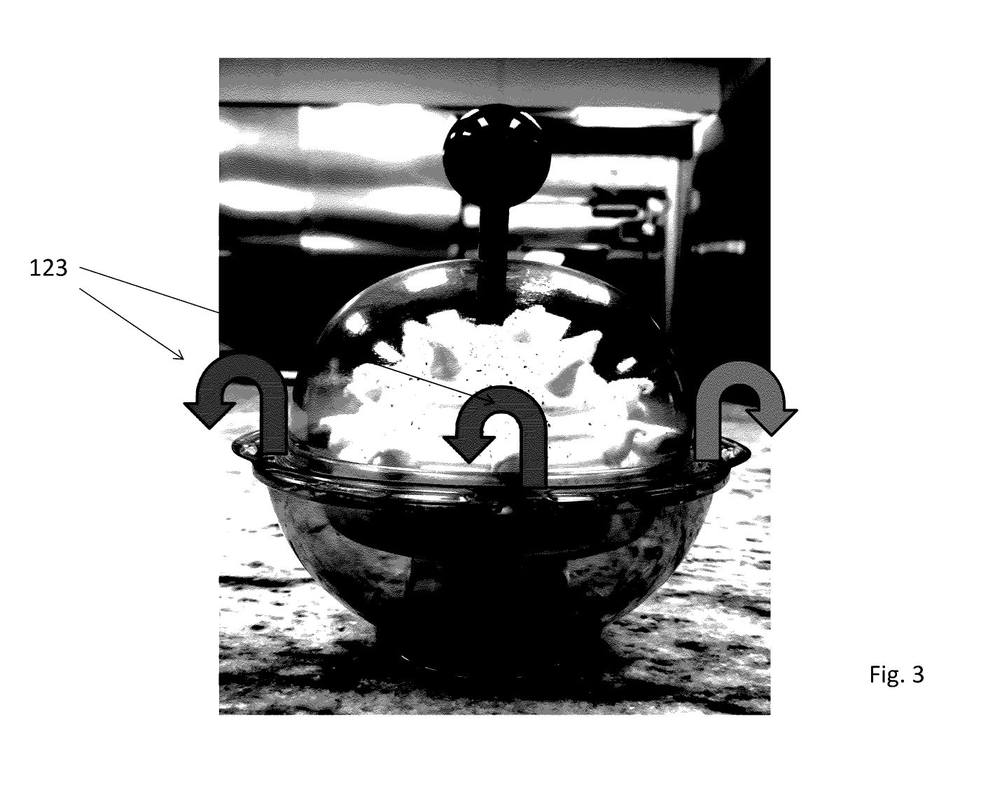

FIGS. 1 and 2 show a container 100 according to the embodiments of the present invention. In broad terms, the container 100 comprises a bowl 110, shallow bowl 120 and lid 130. An optional dropper 140 may be used to enhance the food product as detailed below. FIG. 3 shows a dessert being presented with the container 100 with dry ice and water forming water fog 123 which is able to escape the primary bowl 110. While other food products may be presented, for purposes of brevity, a dessert will be the focus of this description.

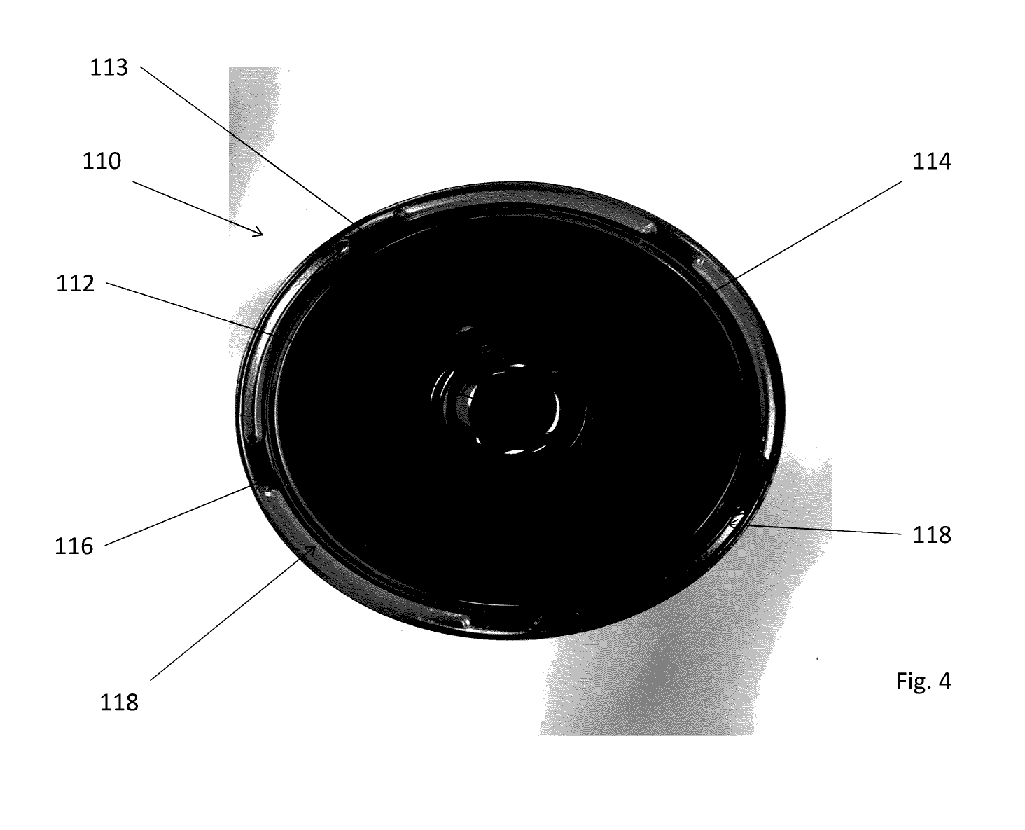

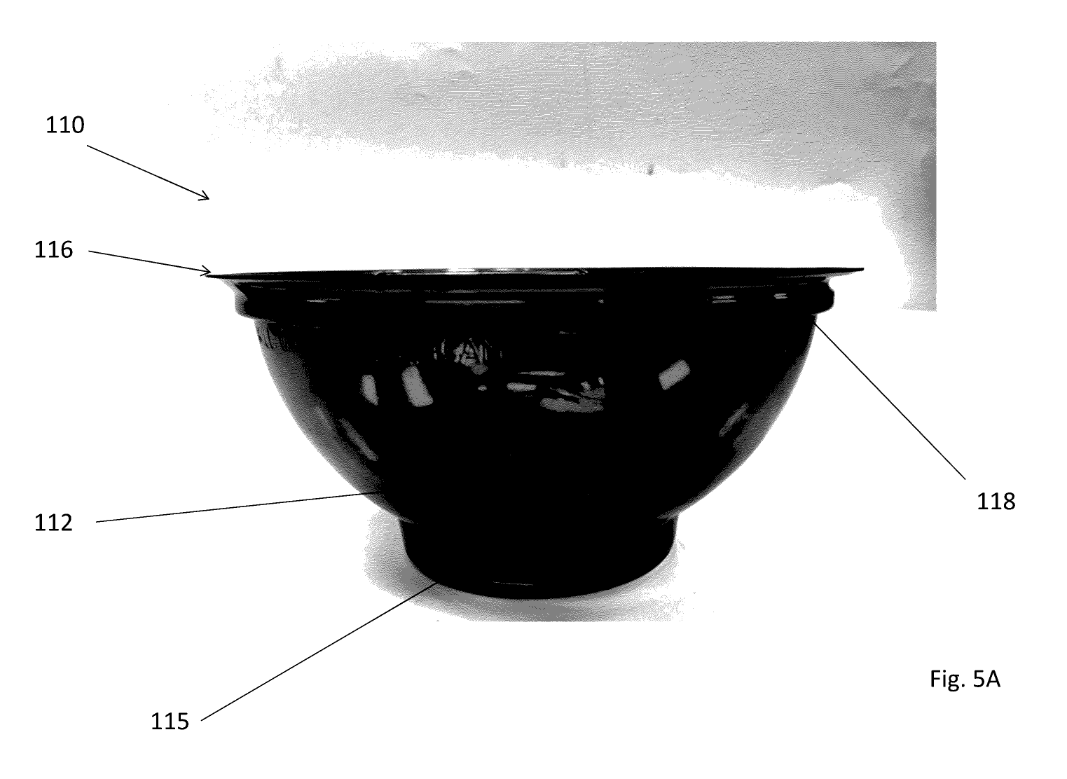

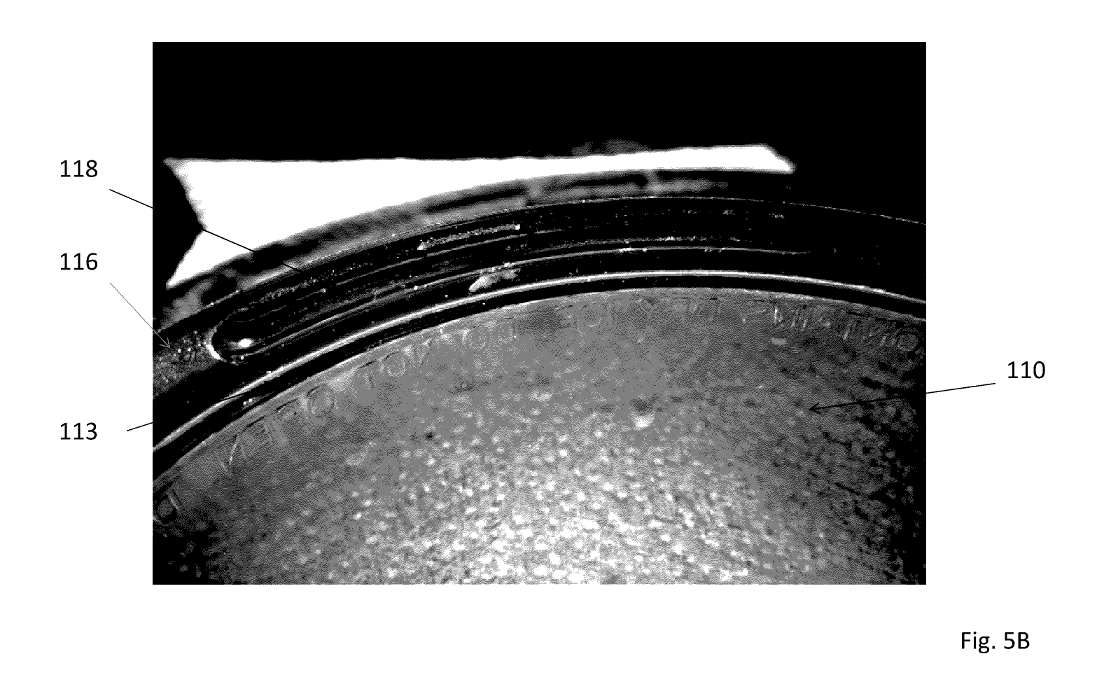

Now referring to FIGS. 4, 5A and 5B, the primary bowl 110 of the container 100 is substantially semi-spherical in shape and includes a center riser 112 therein which creates a circular bowl volume 114. The circular bowl volume 114 receives dry ice (i.e., solid carbon dioxide) and water for reasons detailed below. A pedestal 115 provides a support for the bowl 110 to rest on a flat surface. An outward and upward extending lip 116 circumscribing the top opening of the primary bowl 110 includes a series of spaced, elongated ridges 118 for holding the shallow bowl 120 in place as detailed below. As shown, five elongated ridges 118 are formed on said lip 116, but those skilled in the art will recognize that more or less, and shorter or longer, ridges may be used. The lip 116 extends from an upper edge 113 of the primary bowl 110.

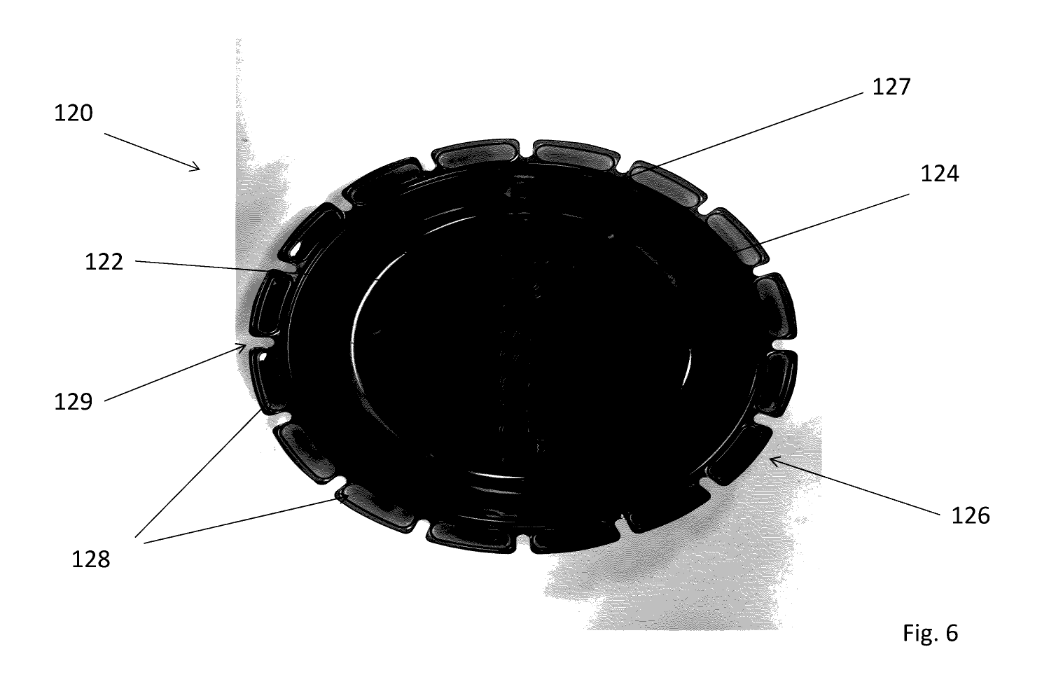

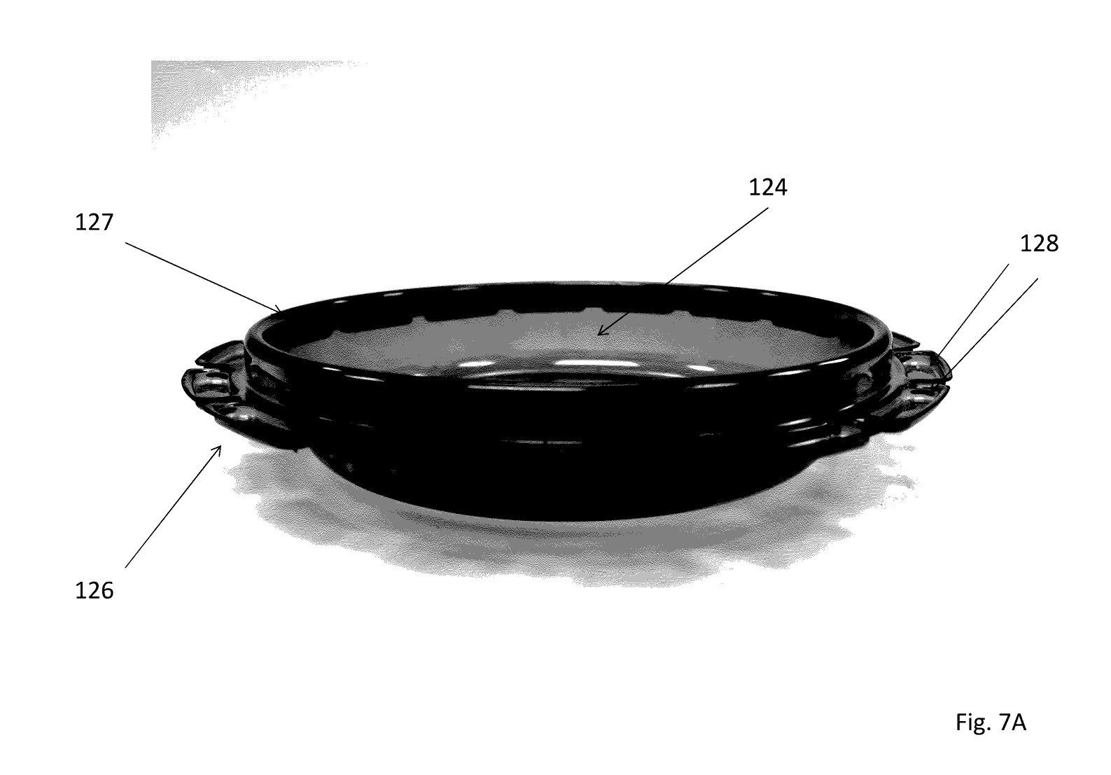

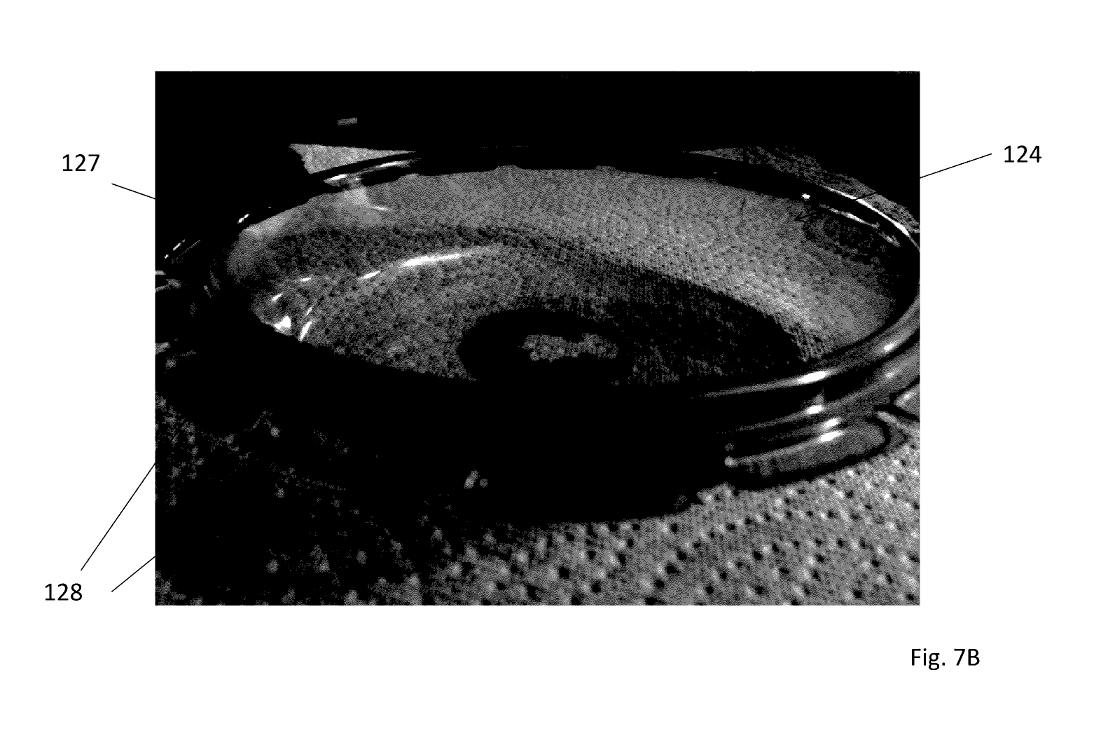

FIGS. 6, 7A and 7B show the shallow bowl 120 which is configured to attach to said primary bowl 110. The shallow bowl 120, when attached to said primary bowl 110, acts as a support for a dessert. The shallow bowl 120 includes a generally flat bottom 122, wall 124 and lip 126 formed of flexible, spaced members 128. The outer lip 126 is positioned slightly below a top rim 127 of the shallow bowl 120 such that top surfaces of the spaced members 128 are below the top rim 127. Attaching the shallow bowl 120 to the primary bowl 110 comprises pushing the shallow bowl 120 downward into the opening of the primary bowl 110 causing the flexible, spaced members 128 to snap in place below the elongated ridges 118 and said upper edge 113 of the primary bowl 110. Spaces 129 between the spaced members 128, form passageways from within said primary bowl 110 to an area outside of said primary bowl 110. In an alternative embodiment, the shallow bowl may be substantially flat as long as it is able to support a food product.

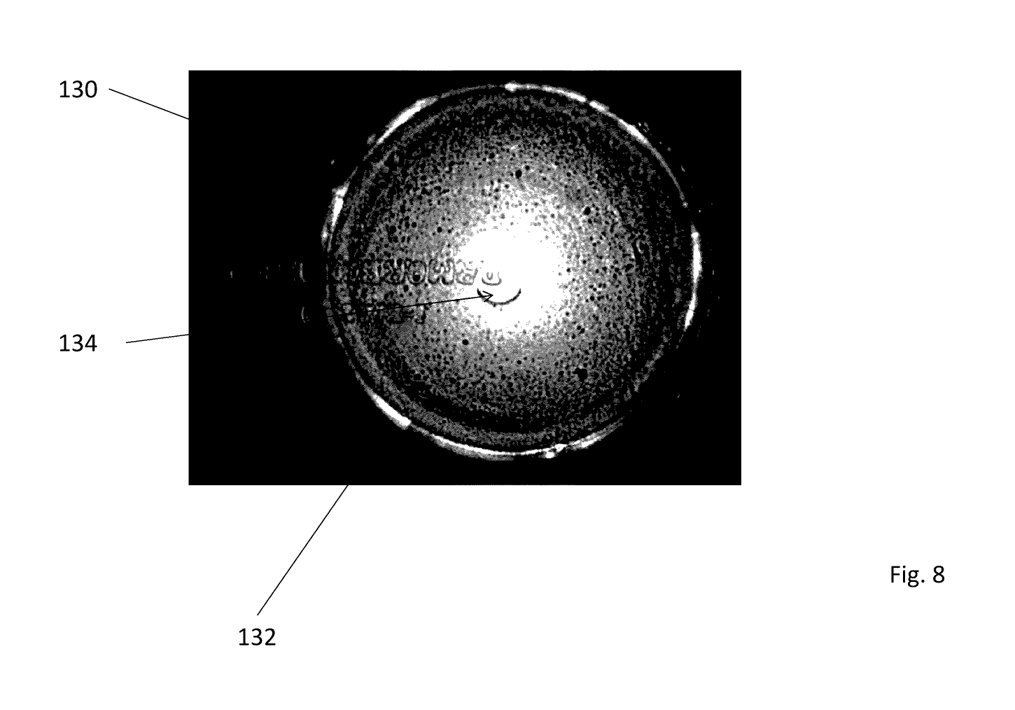

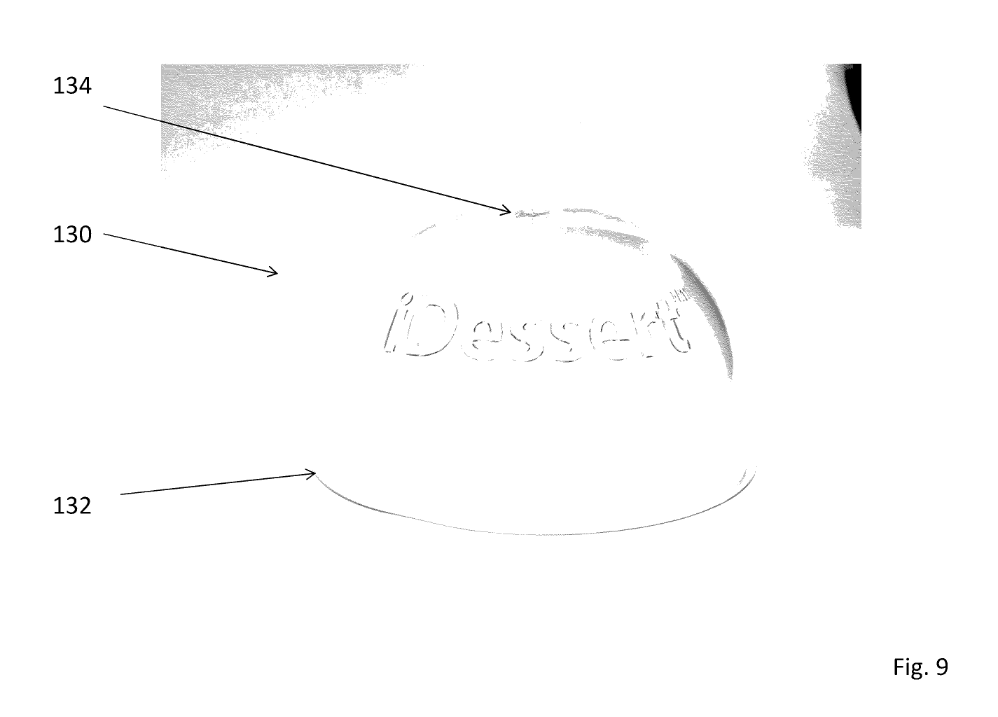

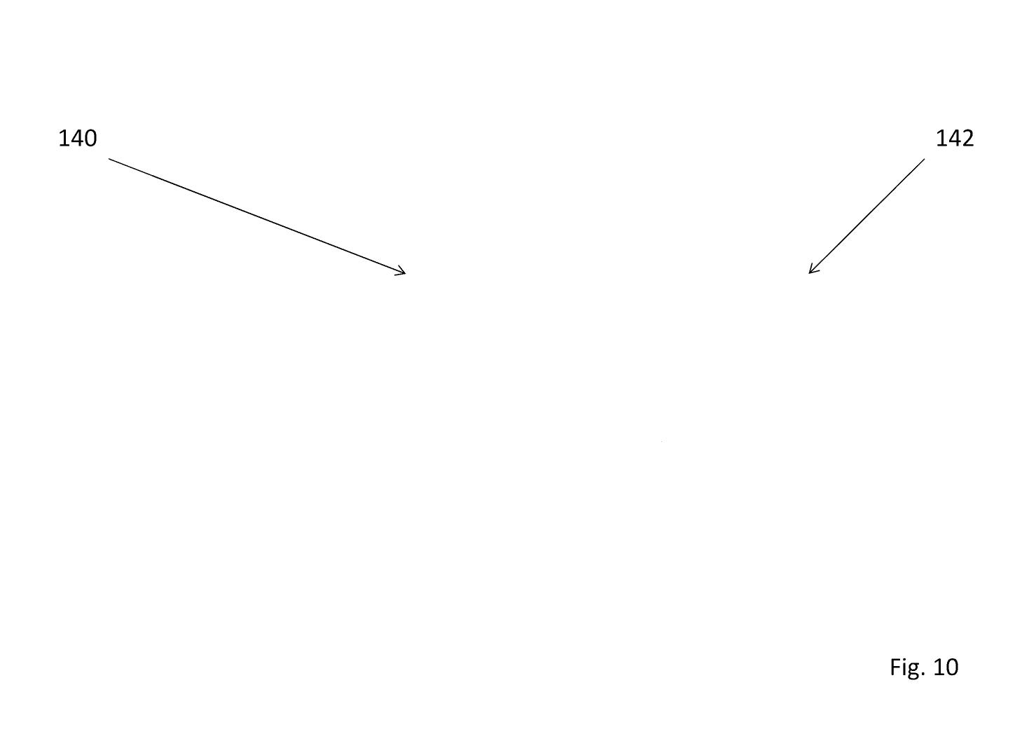

FIGS. 8 and 9 show the lid 130. The lid 130 is semi-spherical in shape and includes a small lip 132 around a bottom thereof. The lid 130 is dimensioned to fit over the shallow bowl 120 and stay on the shallow bowl 120 by means of friction between the lid 130 and outer edge of said top rim 127 of the shallow bowl 120. An opening 134 in the top of the lid 130 permits the insertion of said dropper 140 (shown in FIG. 10) for the purpose of forcing chocolate sauce (or other flavored sauces) into the dessert prior to the consumption thereof.

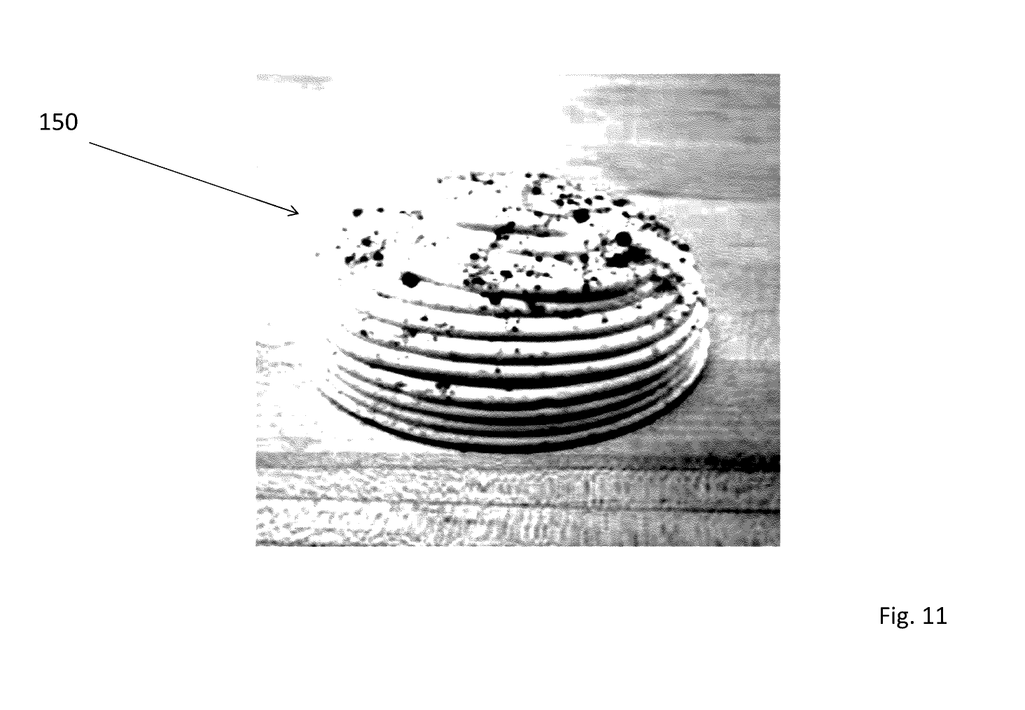

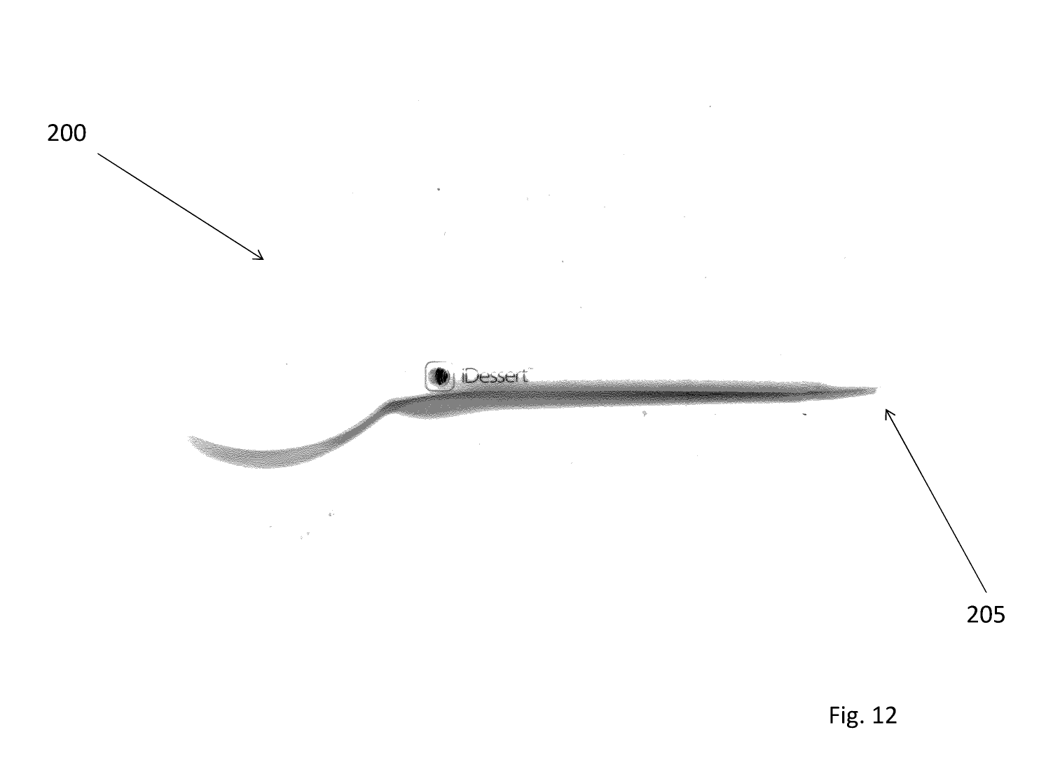

Preparation of the container 100 and dessert presentation comprises: (i) placing dry ice and water in the primary bowl to create a water fog effect; (ii) attaching the shallow bowl 120 to the primary bowl 130; (iii) placing the dessert on the shallow bowl 120 and (iv) placing the lid 130 on the shallow bowl 120. FIG. 3 shows the container 100 with a dessert, dry ice and water creating a water fog effect proximate the container 100 and lid 130. Eating the dessert comprises: (i) using the dropper 140 (with bulb 142 containing a sauce as shown in FIG. 3), via the opening 134 in the lid 130, to insert chocolate sauce into the dessert through a top of the dessert; (ii) removing the lid 130; (iii) utilizing a custom spoon 200 with a breaking tip 205 (shown in FIG. 12) and (iv) eating the dessert. In one embodiment, as shown in FIG. 11, the dessert is a meringue 150 in a semi-spherical shape forming a dome-like appearance. In such an embodiment, the dessert has a hard outer shell which can be broken with the breaking tip 205 of the spoon 200.

In one embodiment, the lid 130 is transparent and the primary bowl 110 and shallow bowl 120 are colored and slightly transparent or opaque. Those skilled in the art will recognize that the primary bowl 110, shallow bowl 120 and lid 130 can be transparent, partially transparent, colored and/or opaque.

Although the invention has been described in detail with reference to several embodiments, additional variations and modifications exist within the scope and spirit of the invention as described and defined in the following claims.

I claim:

1. a container comprising:
a primary bowl; and
a shallow bowl configured to removably attach to said primary bowl near a top of said primary bowl such that an upper surface of said shallow bowl creates a support for a food product, said shallow bowl configured to cover a majority of a top opening of said primary bowl while leaving one or more passageways from within said primary bowl to an area external to said primary bowl, said one or more passageways for allowing water fog from a mixture of dry ice and water placed in said primary bowl and beneath said shallow bowl to escape creating a visual effect proximate said food product.

2. The container of claim 1 further comprising a lid attachable to said shallow bowl.

3. The container of claim 2 wherein said lid has an opening in a top thereof, said opening for passage of a dropper.

4. The container of claim 1 wherein said primary bowl includes a center riser which defines a circular primary bowl volume.

5. The container of claim 1 wherein said shallow bowl is substantially flat.

6. A container comprising:
a primary bowl; and
a shallow bowl configured to removably attach to said primary bowl near a top of said primary bowl such that an upper surface of said shallow bowl creates a support for a food product, said shallow bowl having a lip formed of flexible, spaced members which, when said shallow bowl is attached to said primary bowl, define one or more passageways from within said primary bowl to an area external to said primary bowl, said one or more passageways for allowing water fog from a mixture of dry ice and water placed in said primary bowl and beneath said shallow bowl to escape creating a visual effect proximate said food product.

7. The container of claim 6 further comprising a lid attachable to said shallow bowl.

8. The container of claim 7 wherein said lid has an opening in a top thereof, said opening for passage of a dropper.

9. The container of claim 6 wherein said primary bowl includes a center riser which defines a circular primary bowl volume.

10. A container system comprising:
a primary bowl; and
a shallow bowl configured to removably attach to said primary bowl near a top of said primary bowl such that an upper surface of said shallow bowl creates a support for a food product, said shallow bowl configured to cover a majority of a top opening of said primary bowl while leaving one or more passageways from within said primary bowl to an area external to said primary bowl, said one or more passageways for allowing water fog from a mixture of dry ice and water placed in said primary bowl and beneath said shallow bowl to escape creating a visual effect proximate said food product;
a lid configured to attach to said shallow bowl, said lid having an upper opening; and
a dropper configured to insert through said opening into a dessert on said shallow bowl.

11. The container system of claim 10 further comprising a spoon having a breaking tip configured to insert through said upper opening in said lid and break a hard-shelled dessert positioned on said shallow bowl.
